(19) United States
(12) Patent Application Publication
(10) Pub. No.: US 2026/0091999 A1
(43) Pub. Date: Apr. 2, 2026

(54) HYDRAULIC CIRCUIT CONFIGURATION FOR A VACUUM AIR LIFT SYSTEM AND METHOD OF USING THE SAME

(71) Applicant: Searen, LLC, Cincinnati, OH (US)

(72) Inventors: Thomas W. Andrews, Cincinnati, OH (US); Emmanuel Briquet, Cincinnati, OH (US)

(21) Appl. No.: 19/348,176

(22) Filed: Oct. 2, 2025

Related U.S. Application Data
(60) Provisional application No. 63/702,413, filed on Oct. 2, 2024.

(51) Int. Cl. C02F 1/74

(52) U.S. Cl. CPC C02F 1/74; C02F 2201/005; C02F 2209/40; C02F 2209/42; C02F 2301/063

(57) ABSTRACT

The present disclosure teaches a system for treating an aqueous effluent comprising: an upflow liquid column configured to retain a fluid; a fluid inlet fluidly coupled with the upflow liquid column and positioned at about a bottom of the upflow liquid column; at least one downflow liquid column that is non-concentric with the at least one upflow liquid column; at least one aerator fluidly coupled with the upflow liquid column and operably configured to deliver a gas to the upflow liquid column such that a plurality of bubbles are formed within the upflow liquid column; a gas headspace above a top of the upflow liquid column, wherein the gas headspace is defined at least partially by a cap; an outlet fluidly coupled with the gas headspace; and a vacuum pump, wherein the vacuum pump is operably configured to create a vacuum in the gas headspace.

### CROSS REFERENCE TO RELATED APPLICATION

The present application claims the priority benefit of U.S. Provisional Application No. 63/702,413, filed Oct. 2, 2024, the disclosure of which is hereby incorporated by reference in its entirety.

### TECHNICAL FIELD

Versions of the technology relate, in general, to systems and methods for treating an aqueous effluent. In particular, versions of the technology relate to the removal of Perfluorinated and Polyfluorinated substances (PFAS) from various water sources.

### BACKGROUND

Perfluorinated and Polyfluorinated substances (PFAS), also known as forever chemicals, are a group of chemicals used to make fluoropolymer coatings and products that resist heat, oil, stains, grease, and water. PFAS based coatings can be found in a wide variety of products. These chemicals resist degradation in the environment and have been determined to be harmful to humans and other organisms.

### BRIEF DESCRIPTION OF THE DRAWINGS

The present disclosure can be more readily understood from a detailed description of some example versions taken in conjunction with the following figures:

FIG. 1 is a schematic illustration of a system for treating an aqueous effluent with a center upflow column and downflow columns on the peripheral of the center upflow column.

FIG. 2 is a schematic illustration of a system for treating an aqueous effluent with an upflow column and a downflow column originating in the center of the upflow column.

### DETAILED DESCRIPTION

Various non-limiting versions of the present disclosure can now be described to provide an overall understanding of the principles of the structure, function, and use of the apparatuses, systems, methods, and processes disclosed herein. One or more examples of these non-limiting versions are illustrated in the accompanying drawings. Those of ordinary skill in the art can understand that systems and methods specifically described herein and illustrated in the accompanying drawings are non-limiting versions. The features illustrated or described in connection with one non-limiting version may be combined with the features of other non-limiting versions. Such modifications and variations are intended to be included within the scope of the present disclosure.

Reference throughout the specification to “various versions,” “some versions,” “one version,” “some example versions,” “one example version,” or “a version” means that a particular feature, structure, or characteristic described in connection with any version is included in at least one version. Thus, appearances of the phrases “in various versions,” “in some versions,” “in one version,” “some example versions,” “one example version,” or “in a version” in places throughout the specification are not necessarily all referring to the same version. Furthermore, the particular features, structures or characteristics may be combined in any suitable manner in one or more versions.

PFAS chemicals typically exist in low concentrations in various water streams. Frequently, other contaminants are present in the water stream as well. The ideal solution for their removal should: 1) isolate and capture the targeted contaminants to maximize effectiveness and minimize inefficiencies; 2) process large volumes of water efficiently while providing effective separation; 3) utilize minimal consumables; 4) have a flexible and adaptable approach to accommodate a wide range of waste water streams; and 5) utilize minimal operation and maintenance activities. Furthermore, known techniques for PFAS removal require a large physical footprint, have higher acquisition costs, and consume more energy, thus increasing operating costs.

Described herein are example versions of systems and methods for removing contaminants in the form of chained or branched carbon compounds, either human-made, naturally occurring, or combinations thereof, such as PFAS, VOCs, hormones, DNA, and/or pathogens from a water source.

Prior systems for treating aqueous effluent, while effective, can be optimized to more effectively remove PFAS. Prior systems incorporate upflow and downflow columns in one unit. For example, a vacuum air lift (VAL) system may contain two pipes or columns, with the first column being housed inside of a second, larger column. The smaller, inner pipe could constitute the upflow column. The space in between the larger, outer pipe and the inner upflow column could contain the downward flowing fluid. This configuration can be termed a coaxial or concentric configuration. While effective for many applications, other configurations, such as a non-concentric configuration, may be more effective for PFAS treatment applications.

This presently disclosed system for treating aqueous effluent incorporates a VAL that utilizes a non-concentric configuration optimized for PFAS applications. While prior VAL systems allow treated water outflow to pass through the cavity between the concentrically-arranged inner and outer columns, the present VAL system provides separate, non-concentric columns dedicated to fluid entering or exiting the treatment system. This allows for more precise control over outflow, which may be vital for PFAS treatment because of the persistent nature of PFAS in the environment it is important that all of the process stream be treated effectively and that as much as possible of the contaminant is captured. In previous VAL systems, inadequately treated water that prematurely exited the treatment system could not be recovered. A VAL with a non-concentric configuration allows better control over water entering and exiting the treatment system. For example, a valve or other mechanism can shut off flow to the downflow columns until the water has been fully treated. This feature may be more easily implemented where there is/are independent column(s) dedicated to downflow.

Additionally, the ability of the non-concentric configuration to control outflow enables the present disclosure to accommodate variable volumes of fluid flowing in and out of the treatment system. In one or more versions, a valve, such as a variable flow valve may be used to regulate the amount of flow. This may provide a manufacturing advantage where one sized upflow column could be used with several downflow column of differing sizes/configurations (or vice versa).

The non-concentric configuration presents the opportunity to have greater control of gas diffusion into the upward flowing fluid. Specifically, the non-concentric configuration allows simpler, more flexible management of the gas injection or aeration. Gas diffusion refers to the diffusion of gas into or out of the water stream (in aquaculture carbon dioxide diffuses out while oxygen diffuses in). The suspended particles (PFAS or other contaminants) attach to the gas bubbles creating a foam or froth that rises in the column. In the concentric configuration, gas would have to be inserted through two walls. With the present disclosure, gas could be directly inserted into the upflow column.

The non-concentric configuration also allows for greater structural soundness. Previous VAL systems with a concentric arrangement required the downflow column to have a larger diameter than the upflow column so that the upflow column could be placed inside. In one or more versions of the present system, the column housing the downward flowing fluid can have a smaller diameter than the upflow column as it does not need to house the upflow column. This lowers the hoop stress applied to the column and increases the strength of the column.

There are also cost-saving and manufacturing benefits associated with the non-concentric configuration as the non-concentric configuration requires less material to produce two columns of a smaller diameter than to produce the concentrically-oriented columns. It may also be simpler to manufacture. The strength of the system is increased due to the columns being able to have a smaller diameter than systems without a non-concentric configuration, which means that fewer reinforcing means are required. As stated above, because the gas injection does not have to pass through both cylinders a simpler approach with less sealing and connections is possible. Additionally, standard pipe material can be utilized with less modification and incorporation of valves and sensors is simplified as compared to systems without a non-concentric configuration.

Finally, this non-concentric construction may be specially adapted for applications that require finely tuned treatment processes, such as PFAS treatment applications. In one or more versions, the processes that can be finely tuned with a non-concentric configuration may include residence time, contaminant extraction, and the control of the downflow.

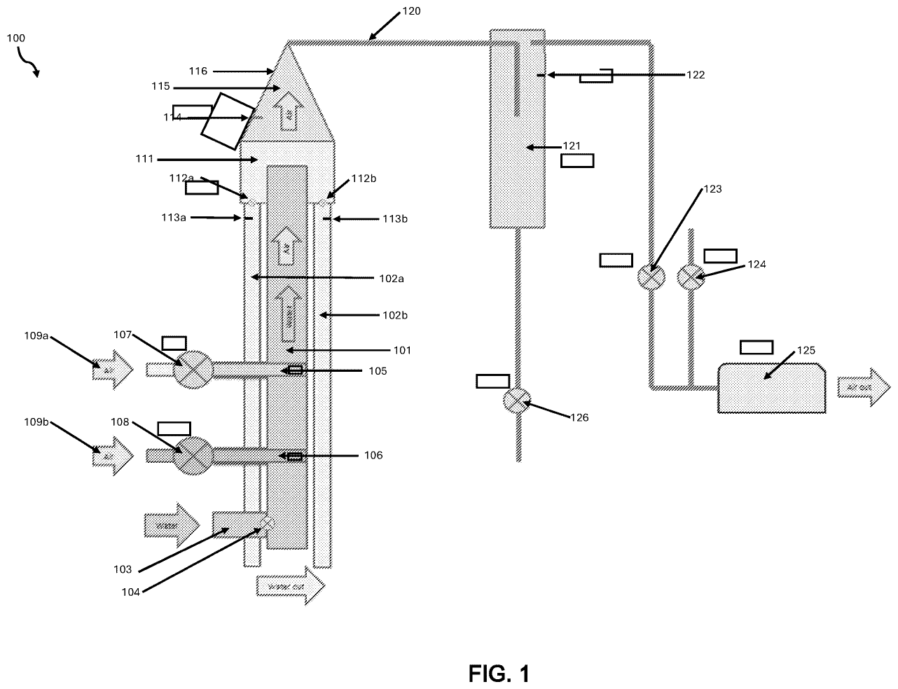

FIG. 1 shows one version of a system for treating an aqueous effluent. VAL installation 100 can include an upflow liquid column 101 and one or more downflow liquid columns 102. In one or more versions, upflow liquid column 101 and downflow liquid column(s) 102 can have a vertical orientation. In one or more versions, upflow liquid column 101 and downflow liquid column(s) 102 can also have a non-concentric, non-coaxial orientation relative to each other. In one or more versions, the upflow liquid column 101 may be located in the center of VAL installation 100 with downflow liquid column(s) 102 located on the periphery of upflow liquid column 101, in a separate non-concentric orientation. This configuration may be referred to as a “peripheral tap” or “peripheral sourced downflow configuration.”

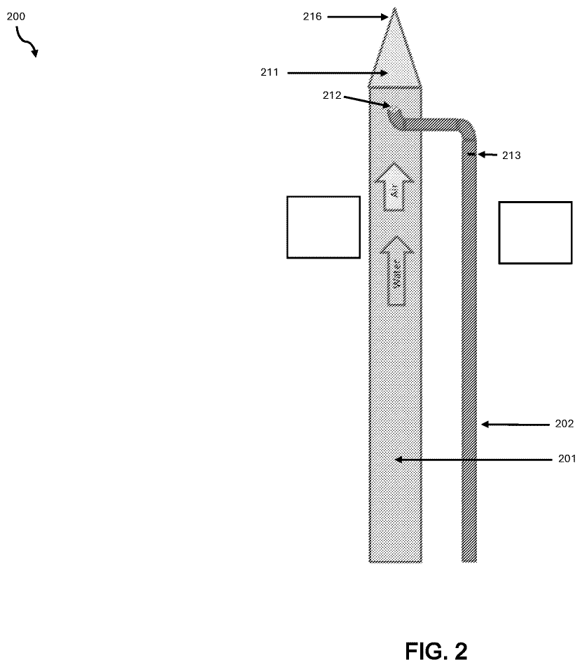

VAL installation 100 can include a fluid inlet 103 for supplying fluid to be treated, which can be positioned at the bottom of upflow liquid column 101. An inlet valve 104 can be used to mediate the flow of fluid from fluid inlet 103 into upflow liquid column 101. A micro-bubble aerator 106 and macro-bubble aerator 105 can be operably configured to inject and distribute a gas, such as a pressurized air, into upflow liquid column 101 and wherein that gas forms a plurality of bubbles within upflow liquid column 101. In one or more versions, the term aerator may be used synonymous with the term diffuser. In one or more versions, micro-bubble aerator 106 and macro-bubble aerator 105 can be connected to one or more sources of pressurized air 109. The injection of a gas from micro-bubble aerator 106 and macro-bubble aerator 105 can be mediated by a micro-bubble aerator control valve 108 and macro-bubble aerator control valve 107. In one or more versions, the micro bubble aerator 106 may be mounted lower on the upflow liquid column 101 than the macro-bubble aerator 105. Although both a micro-bubble aerator and macro-bubble aerator are shown, it is also contemplated that VAL installation 100 may utilize two micro-bubble aerators or two macro-bubble aerators. In one or more versions, it is also contemplated that VAL installation 100 may utilize just one aerator or more than two aerators. Although not shown in FIG. 1 or 2, it can be contemplated that in some versions, a surfactant can be added to the foam waste stream to increase the level of foaming of the foam waste stream, which may assist with increasing PFAS removal

In one or more versions, fluid from upflow liquid column 101 may be aerated and may then form a foam at a headspace 111. Headspace 111 may also be known as a separation space. As shown in the Figures, headspace 111 may act as a liquid/gas border. This may be where the flow separates into a mostly liquid stream (downflow) and a mostly gas stream. Chamber 115 may be utilized for concentrating and directing (funneling) the mostly gas stream to vacuum pump 125. Evacuation tank 121 may be where the foam re-coalesces such that evacuation tank 121 may act as a gas/liquid separator. In one or more versions, headspace 111 may be connected with upflow liquid column 101 and downflow liquid column(s) 102. In one or more versions, fluid enters headspace 111 from upflow liquid column 101 and then flows into downflow liquid column(s) 102. In one or more versions, the flow of fluid into downflow liquid column(s) 102 can be mediated by one or more downflow output valves 112. Downflow output valve(s) 112 may be used to isolate the fluid flowing up and prevent untreated or undertreated fluid from flowing into the downflow liquid column(s) 102. In one or more versions, the downflow output valve(s) 112 may be located at the top of the downflow liquid column(s) 102. In one or more versions, downflow output valve(s) 112 may be automated valves controlled by an efficiency measure, such as suspended solids measurements.

In one or more versions, one or more downflow sensors 113 can be located in any or all of downflow liquid column(s) 102. In one or more versions, downflow sensor(s) 113 may be located at the junction between headspace 111 and downflow liquid column(s) 102. In one or more versions, the one or more downflow sensors 113 may measure pressure, flowrate, and/or water quality. In one or more versions, level sensors may also be used to measure fluid levels. In one or more versions, one or more control level sensors 114 can be located in a chamber 115. Chamber 115 may be a cavity bound by a cap 116.

In one or more versions, an outlet 120 for removing foam and off-gasses that may be formed in headspace 111 can be provided. In one or more versions, VAL installation 100 can be operated as a gas stripper where only gas is extracted. This may occur in applications where there is a large amount of undesirable dissolved gas in the water that needs to be removed. In yet other versions, both suspended particles (PFAS, etc.) and gases may be extracted. In one or more versions, a maximum level sensor 122 can be located in an evacuation tank 121. A vacuum pump 125 and a holding tank drain valve 126 can be connected to evacuation tank 121. In one or more versions, a vacuum pump isolation valve 123 may mediate the flow between evacuation tank 121 and vacuum pump 125. Additionally, a vacuum release valve 124 may also control the discharge of gas from vacuum pump 125.

FIG. 2 shows another version of a VAL system for treating an aqueous effluent. VAL installation 200 may be similar to VAL installation 100 in that it can include an upflow liquid column 201 and one or more downflow liquid columns 202. In one or more versions, VAL installation 200 differs from VAL installation 100 in that the downflow column(s) 202 may originate in the center of the upflow column 201, rather than on the periphery as in VAL installation 100. The configuration of VAL installation 100 may be referred to as a “center tap” or “center sourced downflow” configuration.

The fluid from upflow liquid column 201 may form a foam at a headspace 211. Headspace 211 may also be known as a separation space. Headspace 211 may be defined by a cap 216. In one or more versions, headspace 211 may be connected with downflow liquid column(s) 202 as the bubbles rise past the downflow liquid column(s) 202 because of their higher buoyancy. In one or more versions, the bubbles may collect at the top of the water forming the foam. This may allow treated fluid to flow from headspace 211 into downflow liquid column(s) 202. In one or more versions, the flow of fluid into downflow liquid column(s) 202 can be mediated by one or more downflow output valves 212. Downflow output valve(s) 212 may be used to isolate the fluid flowing up and prevent untreated or undertreated fluid from flowing into the downflow liquid column(s) 202. In one or more versions, the downflow output valve(s) 212 may be located at the top of the downflow liquid column(s) 202. In one or more versions, downflow output valve(s) 212 may be automated valves controlled by an efficiency measure, such as suspended solids measurements. In one or more versions, one or more downflow sensors 213 can be located in downflow liquid column(s) 202.

In one example version, bio-film elements can be incorporated into the upflow and/or downflow elements of VAL installations 100 and 200. In some versions, VAL installations 100 and 200 can include a fluidic oscillator. In some versions, VAL installations 100 and 200 can include a flow management system. In one or more versions, VAL installations 100 and 200 can be operated in a batch or flow-thru mode as desired for the particular influent water source utilized within VAL installations 100 and 200. In one or more versions, VAL installations 100 and 200 may be operated in series or cascaded with other VAL systems to achieve a higher concentration of the removal of targeted fine solids. In one or more versions, the VAL installations 100 and 200 may be effective at removing particles that attach to the rising bubble stream within the VAL installations 100 and 200. Chained particles are effective at attaching to the rising bubble stream because they drape over the bubbles. In one or more versions, contaminants having a carbon chain of 4 or more atoms leads to near 100% removal and contaminants having a carbon chain of 6 or more atoms leads to 100% removal.

The VAL installations 100 and 200 may separate the screened influent water stream into a foam waste stream and into a cleaned water stream. The foam waste stream can include captured suspended solids (PFAS) and the extracted dissolved gases from the screened influent water stream. The foam waste stream can be a small fraction of the overall flow of the original influent stream. In one or more versions, the foam waste stream can include from less than 0.1 percent to 5.0% of the overall flow of the original influent stream, depending on the level of contaminants in the influent stream.

The foam waste stream leaving an outlet pipe (such as outlet 120) can then be passed through a defoaming device that separates the foam waste stream into a gaseous stream and a contaminated liquid stream. The contaminated liquid stream may contain the materials targeted by VAL installations 100 and 200, namely the targeted fine solids, such as PFAS. The contaminated liquid stream can then be passed through to a destruction device to destroy the targeted fine solid, such as PFAS. In one or more versions, the destruction device can utilize chemical destruction, electrical destruction, or thermal destruction. In one or more versions, the destruction device can be an incinerator. In yet other versions, the destruction device can be a pyrolysis system, plasma arc gasification, microwave disposal, fluidized bed combustion, rotary kilns, high temperature oxidation, autoclaves, chemical oxidation, chemical reduction, chemical precipitation, chemical neutralization, chemical hydrolysis, chemical polymerization, chemical dichlorination, chemical stabilization, chemical digestion, chemical leaching control, chemical adsorption, chemical decontamination, plasma arc waste disposal, electrochemical waste disposal, electrocoagulation, electrodialysis, electrooxidation, electric arc furnaces, electrostatic precipitators, electro plasma, pulsed electric field technology, or combinations thereof.

The gaseous stream can then either be discharged, as it may be likely that the gaseous stream contains no contaminants. However, the gaseous stream can also be routed into a destruction device to destroy any contaminants that remain in the stream. In one or more versions, the destruction device may utilize chemical destruction, electrical destruction, or thermal destruction. In one or more versions, the destruction device can be an incinerator. In yet other versions, the destruction device can be a pyrolysis system, plasma arc gasification, microwave disposal, fluidized bed combustion, rotary kilns, high temperature oxidation, autoclaves, chemical oxidation, chemical reduction, chemical precipitation, chemical neutralization, chemical hydrolysis, chemical polymerization, chemical dichlorination, chemical stabilization, chemical digestion, chemical leaching control, chemical adsorption, chemical decontamination, plasma arc waste disposal, electrochemical waste disposal, electrocoagulation, electrodialysis, electrooxidation, electric arc furnaces, electrostatic precipitators, electro plasma, pulsed electric field technology, or combinations thereof.

The cleaned water stream can then be routed to a polishing system. A polishing system can be utilized for trace contaminant removal for use in high purity applications. In one or more versions, a polishing system can be selected from a granular activated carbon system, an ion-exchange system, a nano-filtration system, a reverse osmosis filtration system, or combinations thereof. However, since it may be likely that most of the contaminants are removed by the VAL installation 100 and 200, the burden and operating costs associated with running a polishing system may be greatly reduced.

A polishing system can produce a polished waste water stream and a treated water stream. In one or more versions, a polished waste water stream may consist of discharge from a reverse osmosis system if a reverse osmosis system is utilized as a polishing system or contaminated granular activated carbon is a granular activated carbon system is utilized as a polishing system. If a granular activated carbon system is utilized, in one or more versions the granular activated carbon can be recycled by heating it to drive out the contaminants which can then be destroyed, and the rejuvenated or regenerated granular activated carbon can be returned to service. A polished waste water stream can then be sent to a destruction device to destroy any contaminants. In one or more versions, a destruction device can utilize a chemical destruction, electrical destruction, or thermal destruction. In one or more versions, a destruction device can be an incinerator. In yet other versions, a destruction device can be a pyrolysis system, plasma arc gasification, microwave disposal, fluidized bed combustion, rotary kilns, high temperature oxidation, autoclaves, chemical oxidation, chemical reduction, chemical precipitation, chemical neutralization, chemical hydrolysis, chemical polymerization, chemical dichlorination, chemical stabilization, chemical digestion, chemical leaching control, chemical adsorption, chemical decontamination, plasma arc waste disposal, electrochemical waste disposal, electrocoagulation, electrodialysis, electrooxidation, electric arc furnaces, electrostatic precipitators, electro plasma, pulsed electric field technology, or combinations thereof.

In one or more versions, a treated water stream can be a highly purified water source. In one or more versions, a treated water stream may provide a constant source of treated water for the growth of organisms or as potable water for human consumption.

Numerous advantages can be associated with VAL installations 100 and 200 of the present disclosure. Such advantages include a reduced energy consumption, a smaller footprint yielding improved space efficiency, lower capital costs, reduced facility heat or air-conditioning, reduced facility ventilation requirements, reduced noise generation, a reduced load on the post-treatment of the effluent, a high concentration factor minimizes destruction and disposal costs, high volume capacity of influent into the system, modularity, flexibility, adaptability, reduction of waste streams by 100x or 1000x less than the influent volume, optimization of treatment strategy based on influent characteristics, minimization of contaminants, reduced demand for expensive processes, and the use of VAL installations 100 and 200 provides airlift pumping which may eliminate the need for a process pump. Further, if a granular activated carbon system is utilized as a polishing system, by utilizing VAL installations 100 and 200 prior to the water stream entering the polishing system, the VAL installations 100 and 200 can remove longer chain PFAS compounds which preferentially load granular activated carbon filters at the expense of short chain PFAS compounds which leads to early breakthrough and the need for frequent replacement of the granular activated carbon.

In general, it can be apparent to one of ordinary skill in the art that at least some of the versions described herein can be implemented in many different versions of software, firmware, and/or hardware. The software and firmware code can be executed by a processor or any other similar computing device. The software code or specialized control hardware that can be used to implement versions is not limiting. For example, versions described herein can be implemented by computer software using any suitable computer software language type, using, for example, conventional or object-oriented techniques. Such software can be stored on any type of suitable computer-readable medium or media, such as, for example, a magnetic or optical storage medium. The operation and behavior of the versions can be described without specific reference to specific software code or specialized hardware components. The absence of such specific references is feasible, because it is clearly understood that artisans of ordinary skill would be able to design software and control hardware to implement the versions based on the present description with no more than reasonable effort and without undue experimentation. Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on several types of computer-readable media.

In various versions disclosed herein, a single component can be replaced by multiple components and multiple components can be replaced by a single component to perform a given function or functions. Except where such substitution would not be operative, such substitution is within the intended scope of the versions.

The foregoing description of versions and examples has been presented for purposes of illustration and description. It is not intended to be exhaustive or limiting to the forms described. Numerous modifications are possible in light of the above teachings. Some of those modifications have been discussed, and others can be understood by those skilled in the art. The versions were chosen and described in order to best illustrate principles of various versions as are suited to particular uses contemplated. The scope is, of course, not limited to the examples set forth herein, but can be employed in any number of applications and equivalent devices by those of ordinary skill in the art. Rather it is hereby intended that the scope of the disclosure be defined by the claims appended hereto.

What is claimed is:

1. A system for treating an aqueous effluent comprising:
a. an upflow liquid column, wherein the upflow liquid column is configured to retain a fluid;
b. a fluid inlet, the fluid inlet being fluidly coupled with the upflow liquid column, wherein the fluid inlet is positioned at about a bottom of the upflow liquid column;
c. at least one downflow liquid column, wherein the at least one downflow liquid column is non-concentric with the at least one upflow liquid column;
d. at least one aerator, the at least one aerator being fluidly coupled with the upflow liquid column, wherein the at least one aerator is operably configured to deliver a gas to the upflow liquid column such that a plurality of bubbles are formed within the upflow liquid column;
e. a gas headspace above a top of the upflow liquid column, wherein the gas headspace is defined at least partially by a cap;
f. an outlet fluidly coupled with the gas headspace; and
g. a vacuum pump, wherein the vacuum pump is operably configured to create a vacuum in the gas headspace.

2. The system of claim 1, wherein the at least one upflow liquid column has a vertical orientation, a diameter, and a height.

3. The system of claim 2, wherein the at least one downflow liquid column has a top and a bottom, a vertical orientation, a diameter, and a height.

4. The system of claim 3, wherein the diameter of the at least one downflow liquid column is smaller than the diameter of the at least one upflow liquid column.

5. The system of claim 3, wherein the height of the at least one upflow liquid column is greater than the height of the at least one downflow liquid column.

6. The system of claim 1, comprising a first aerator and a second aerator, wherein the first aerator is operably configured to deliver micro-bubbles to the upflow liquid column and wherein the second aerator is operably configured to deliver macro-bubbles to the upflow liquid column.

7. The system of claim 1, further comprising an evacuation tank associated with the outlet.

8. The system of claim 1, wherein the at least one downflow column receives inflow from a periphery of the gas headspace.

9. The system of claim 1, wherein the at least one downflow column receives inflow from a center of the gas headspace.

10. The system of claim 1, wherein one or more downflow sensors are located in the at least one downflow liquid column.

11. The system of claim 1, wherein one or more control level sensors are located in the gas headspace.

12. The system of claim 1, wherein one or more valves control a flow of fluid to the at least one downflow liquid column.
